(19) United States
(12) Patent Application Publication
(10) Pub. No.: US 2011/0311083 A1
(43) Pub. Date: Dec. 22, 2011

(54) PORTABLE AUDIO DEVICE WITH MICROPHONE AND CONTROLLER

(75) Inventor: Betty Bennett, Pacific Palisades, CA (US)

(73) Assignee: APOGEE ELECTRONICS CORPORATION, Santa Monica, CA (US)

(21) Appl. No.: 12/820,118

(22) Filed: Jun. 21, 2010

(51) Int. Cl. H04R 5/02; H04R 3/00

(52) U.S. Cl. 381/306; 381/122

(57) ABSTRACT

A portable audio device with microphone and controller includes a generally portable housing; an aperture in the housing having sides sloped between 15 and 45 degrees relative to a central axis of the aperture with a large end that opens out of the housing and a small end that opens into the housing; a microphone inside the housing, in line with the aperture, so that sound enters the device and passes to the microphone; an audio output that provides an audio signal representing the sound; a meter on the housing that displays an input level for the microphone and an output level for the audio output; and a controller that controls the input level and the output level. An elastomer dampener for the microphone resists vibrations. Other inputs include an external connection for a musical instrument, second microphone or other input with a 48-volt power source.

### BACKGROUND OF THE INVENTION

The present invention generally relates to audio recording and more specifically to a portable audio device with microphone and controller.

Recording generally requires separate components to be connected together in series to accomplish the task. These components include a microphone, a microphone pre-amplifier, a microphone powering circuit delivering a specific voltage and current, a musical instrument input for directly connecting an instrument that normally requires amplification, an input switcher, a audio meter that is calibrated in volume units, analog to digital converter (A/D), a digital to analog converter (D/A), a volume control circuit and an audio output capable of delivering an amplified signal to a monitoring apparatus such as headphones or loudspeakers.

Existing computers may have rudimentary interfaces for audio input. These computers may not be portable, or may not be small enough to be held in a hand or pocket.

It would be desirable to have a portable audio device that acts as an audio interface to a and that provides a standard of performance that is otherwise offered by systems with separate components.

### SUMMARY OF THE INVENTION

In one aspect of the present invention, a device includes a portable housing having a wall; an aperture in the wall; a microphone inside the housing, in line with the aperture; a controller that extends out of the wall; and an audio output; wherein the device receives sound through the aperture, provides an audio signal representing the sound through the audio output, and controls the strength of the audio signal with the controller.

In another aspect of the present invention, a device includes a generally portable housing; an aperture in the housing having sides sloped between 15 and 45 degrees relative to a central axis of the aperture with a large end that opens out of the housing and a small end that opens into the housing; a microphone inside the housing, in line with the aperture, so that sound enters the device and passes to the microphone; an audio output that provides an audio signal representing the sound; a meter on the housing that displays an input level for the microphone and an output level for the audio output; and a controller that controls the input level and the output level.

In yet another aspect of the present invention, a method of providing an audio signal includes passing sound through an aperture in the wall of a portable housing; receiving the sound into a built-in microphone inside the housing, located at an end of the aperture; amplifying an audio signal from the microphone; utilizing a controller that extends out of the housing to control the amplification of the audio signal; and providing the amplified signal to an audio output.

### BRIEF DESCRIPTION OF THE DRAWINGS

FIG. 1A is a top view of an embodiment of the present invention;

FIG. 1B is a ¾ view of an embodiment;

FIG. 2 illustrates the top panel visual indicators of an embodiment;

FIG. 2A is a detail view of the top panel indicators of an embodiment;

FIG. 3A is a back view of an embodiment;

FIG. 3B is a front view of an embodiment;

FIG. 4 shows an embodiment in use, turning the encoder;

FIG. 5 shows an embodiment in use, pushing the encoder;

FIG. 6 shows an embodiment with peripheral connections;

FIG. 7 shows an embodiment connected to a computer or other host;

FIG. 8 shows an embodiment connected to headphones;

FIG. 9 shows an embodiment with microphone and instrument input connectors;

FIG. 10 shows an embodiment in an audio recording situation with a musical instrument;

FIG. 11 shows an embodiment in another audio recording situation with a microphone;

FIG. 12 shows an embodiment in a playback situation;

FIG. 13 shows two embodiments used to record voice;

FIG. 14 shows the detail of embodiments of the icons to provide visual feedback to the user;

FIG. 15 shows an embodiment of a display-input icon;

FIG. 16 shows an embodiment of a display-output icon;

FIG. 17 shows an embodiment of a sound chooser window;

FIG. 18 shows an embodiment of a sound input control panel for a computer;

FIG. 19 shows an embodiment of a sound output control panel;

FIG. 20 shows an embodiment of a control panel from a host application;

FIG. 21 shows an embodiment of a control panel to control the device remotely;

FIG. 22 shows another embodiment of a control panel to control the device remotely; and

FIG. 23 shows an embodiment of a control panel to control audio volume and mixing.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides a portable audio device with microphone and controller. Embodiments of the present invention may provide audio recording without a contained sound studio or stage. Embodiments may combine audio recording components in a miniature or otherwise portable package that is capable of performing the same tasks as the separate, specialized components. An embodiment may be remotely controlled from a host computer or computing device including, but not limited to, a tablet computing device and may utilize the settings stored by such device. Embodiments may include visual feedback in several ways, directly from the device itself, using visual light indicators from electronic sources including, but not limited to LED's, OLED's, LCD's or other means of displaying visual information from electronic inputs.

Embodiments may acquire audio from a sound source utilizing a built-in electret condenser element (microphone) combined with an accompanying pre-amplifier and gain control circuit. An embodiment may include the facility to utilize a standard microphone including dynamic, condenser, tube, ribbon, carbon or another mode of transduction. An embodiment may incorporate a musical instrument interface for instruments that feature a transducer that converts acoustical energy to electrical energy needing amplification to be recorded, reproduced or broadcast. An embodiment may incorporate a means to control audio input levels, switch audio input sources, switch from controlling audio inputs and outputs, and to control audio output levels. An embodiment may provide visual confirmation of audio sources selected, the presence of a voltage and current necessary to power condenser type microphones, and monitoring of both input and output levels. An embodiment may provide remote control of computer or other host programs that manipulate audio and video signals, and the embodiment may be controlled by same. An embodiment may include a graphic user interface (GUI) enabled by the host computer, which can also act as a remote control for the embodiment.

An embodiment may include a portable audio interface with a plurality of available audio inputs, including an integrated electret condenser microphone. The integrated microphone assembly may have an acoustically tuned aperture, sloped to have a conical mouth and a narrow stem such as a funnel, specifically tuned with a chamfer or sloped sides of 60 degrees (with a range of 45˜75 degrees) on the horizontal axis and 30 degrees (with a range of 15˜45 degrees) on the vertical axis to offer a highly linear frequency response to provide a high resolution, low distortion recording. The integrated microphone assembly may be elastomer damped to resist extemporaneous vibrations to provide accurate, low distortion audio recordings and linear frequency response. An embodiment may include external musical instrument input and external microphone inputs with variable gain control on both inputs and outputs, analog to digital (A/D) and digital to analog conversion (D/A), including volume control, visual audio metering and status indicators. Analog signals, such as the input to the A/D or the output of the D/A, may include audio signals, which may represent sound, speech, singing, or other music. An embodiment may include condenser microphone powering circuit of 48 volts and provide a minimum of 25 milliamps including visual indication of engagement. An embodiment may receive sound through the aperture, provide an audio signal representing the sound through the audio output, and control the strength of the audio signal with the controller.

An embodiment may be self-contained, not requiring mains voltage to operate and may be powered by a computer or other host capable of a low voltage power source. The device may be “portable” in that it is enclosed in a housing that is generally small enough to fit in a hand, be easily carried or moved, and be operated while held. Embodiments may be, for example, from 120 mm. to 240 mm. in length, and 56 mm. to 120 mm. in width. One embodiment might be, for an approximate example, 120 mm. length by 58 mm. width, and the height or depth might be 20 mm. for the housing and 27.6 mm. for the housing with encoder. The housing may be an enclosure, possibly made of hard plastic that holds the internal electronics. The housing may have walls that act as faces or boundaries between the inside and outside of the device, and which may have holes, apertures, or elements that extend through the walls. One wall will generally be on a top face of the device, to hold an encoder and visual displays. Embodiments may be mounted on a microphone stand, a standard tripod, or directly on a table top, music stand, or clip. Embodiments may be able to be easily carried or moved, especially because the device may be light and small. The embodiment may include a controller, capable of controlling software on a host computer or tablet device and being remotely controlled by same, possibly utilizing a GUI type interface. An embodiment may utilize an onscreen “Heads Up” display with display icons to monitor and change audio sources, audio gain and audio volume settings. Embodiments may include on-board audio metering of both input and output signals, including but limited to LED, LCD, OLED or other means from signal voltage to visual representation. Embodiments may include a plurality of mounting methods in addition to being a portable device, including microphone stand, tripod, desktop, mountable clip or camera mount.

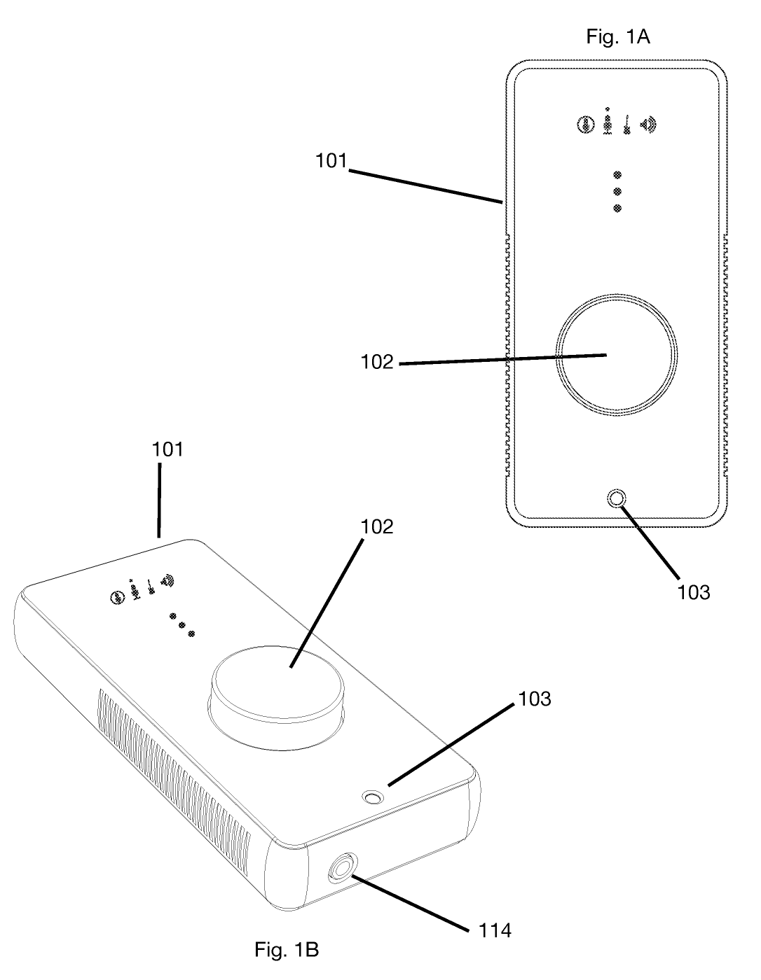

FIG. 1A depicts an embodiment of a portable audio device 101, having an encoder 102 to control the device and a built-in microphone 103. FIG. 1B also shows a monitor/speaker output 114.

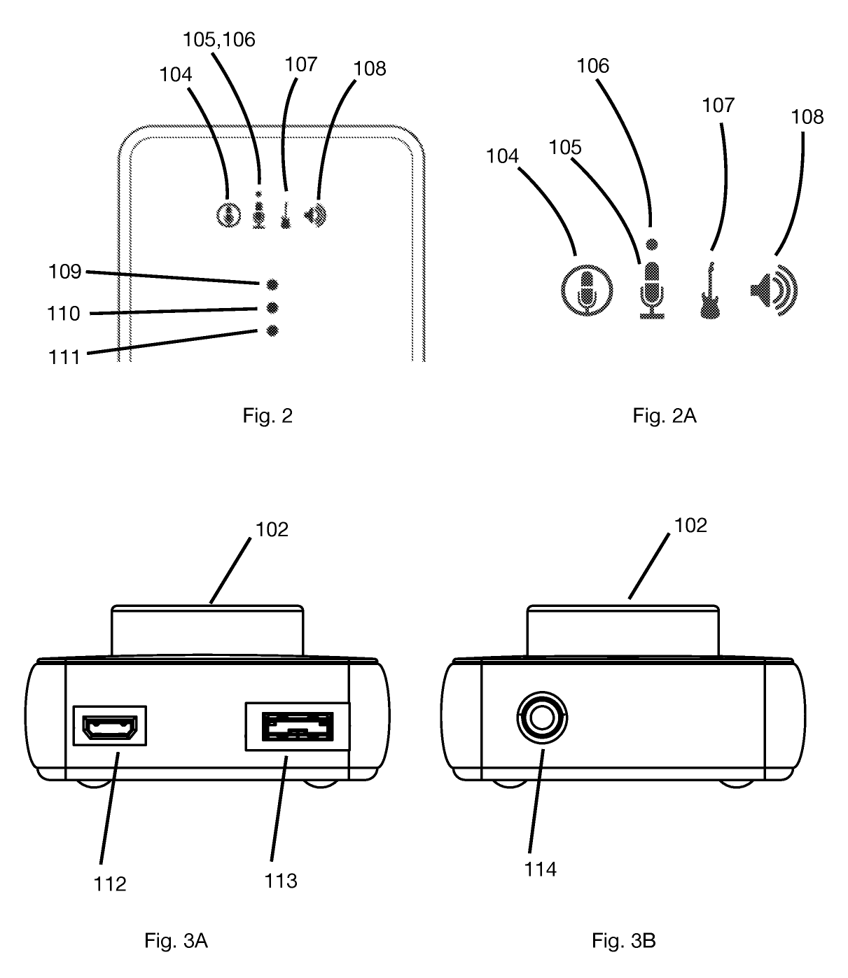

FIGS. 2 and 2A depict an embodiment showing graphical icons, including an internal mic icon 104, an external mic icon 105 with a 48v phantom power icon 106, a instrument input icon 107, and an output icon 108. FIG. 2 depicts indicators including a red LED 109, an amber LED 110, and a green LED 111.

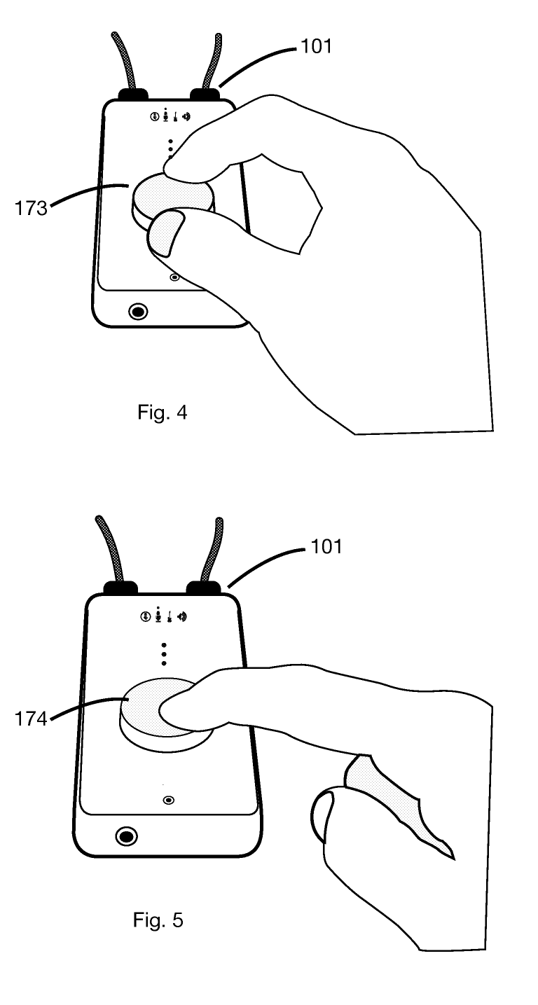

FIG. 3A depicts an embodiment with an output connector 113 and a USB/computer connector 112. FIG. 3B depicts an embodiment with a monitor/speaker output 114.

FIG. 4 depicts an embodiment of the device 101 in use, where the encoder/controller is being turned 173 in a direction to raise or lower system gain or output volume. FIG. 5 depicts an embodiment in use where the encoder is being depressed 174 to change the mode or input.

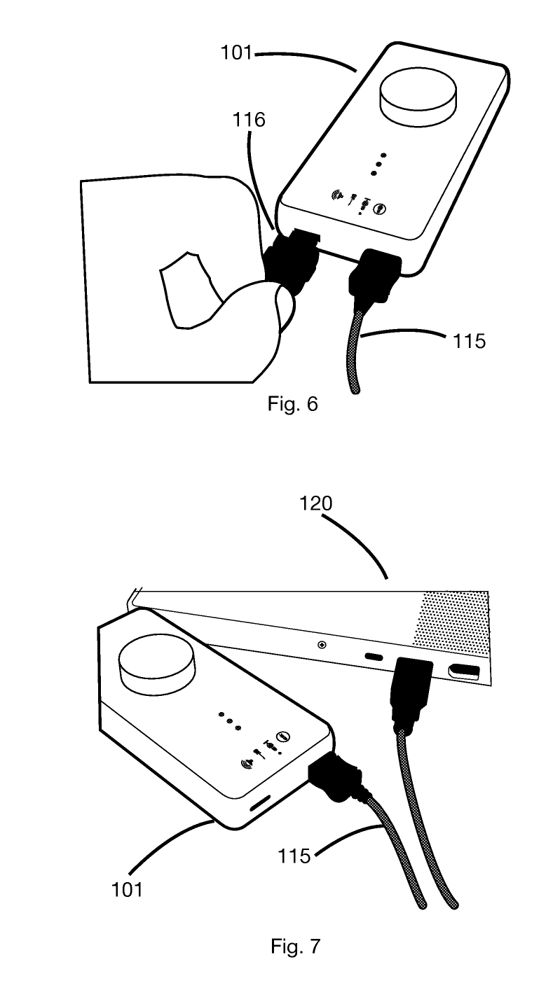

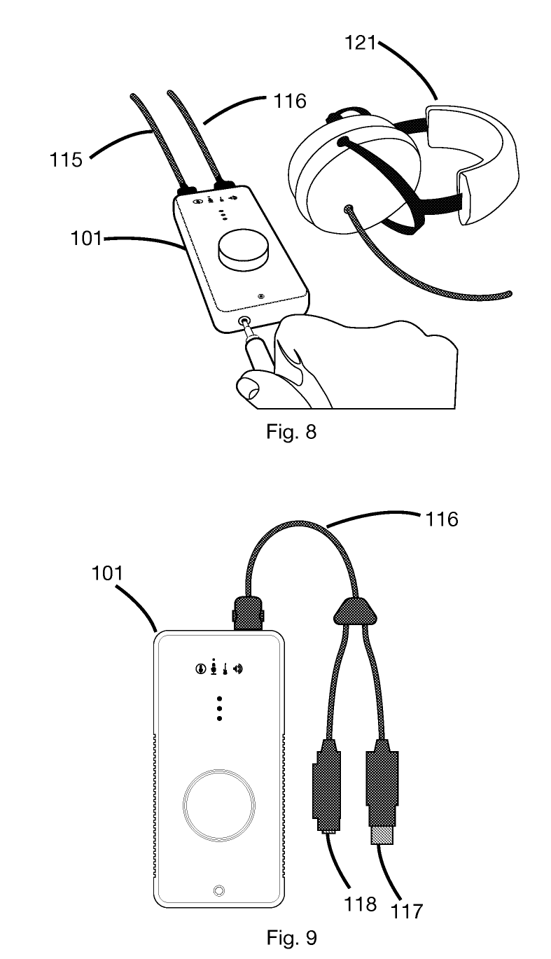

FIG. 6 depicts an embodiment with peripheral connections, including a USB cable 115 and a breakout cable 116. FIG. 7 shows the USB cable 115 connected to a computer host 120. FIG. 8 shows a connection to headphones 121 in a simple audio playback system. FIG. 9 depicts the breakout cable 116 having a microphone connector 117 and an instrument input connector 118.

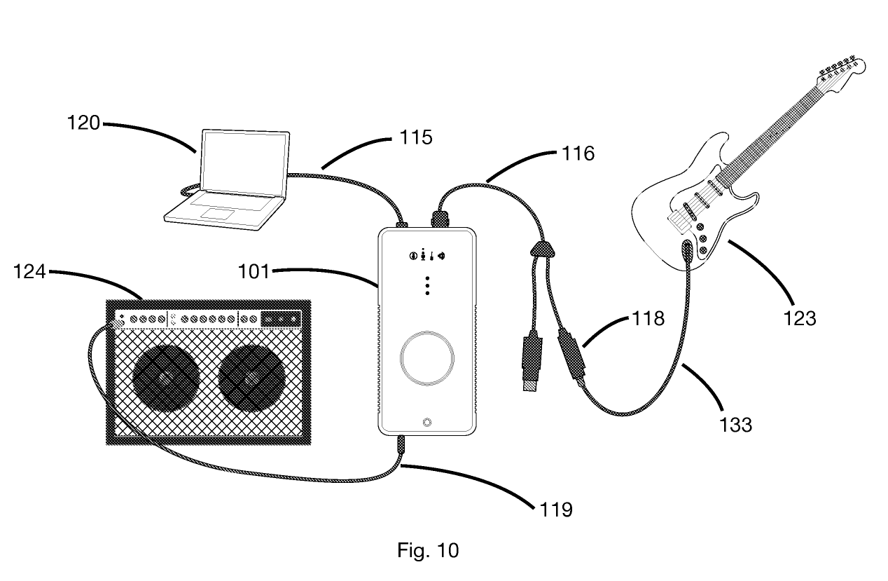

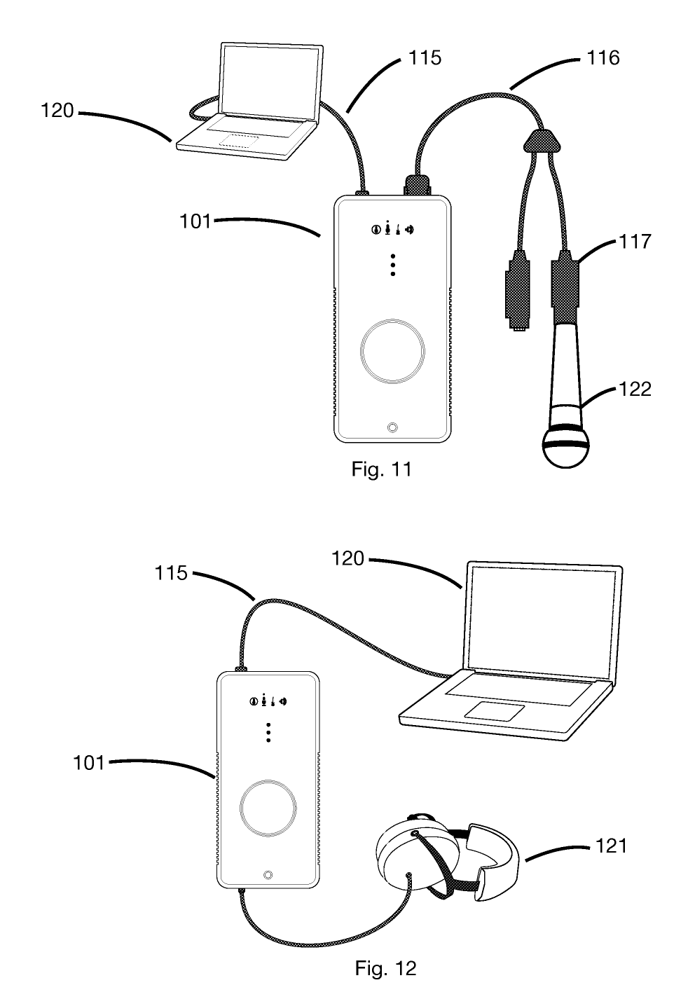

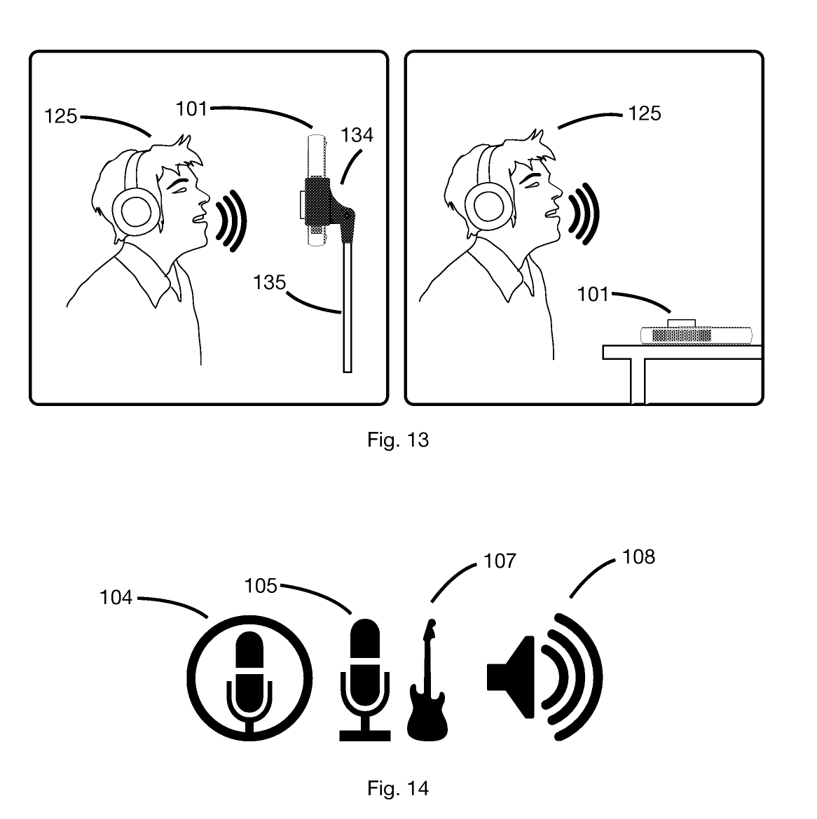

FIG. 10 depicts an embodiment utilized in a more advanced audio recording situation, connected with a guitar cable 133 to a musical instrument 123 such as a guitar, a USB cable 115 to the computer host 120, and an output connector 119 connected to an instrument amplifier 124 for audio reproduction. FIG. 11 depicts an embodiment utilized with an external microphone 122. FIG. 12 depicts an embodiment utilized with headphones 121.

FIG. 13 depicts an embodiment of an audio device 101 with a voice source 125 such as a singer or other voice talent. The device 101 may be held by a microphone clip 134 or mounted on a microphone stand 135, as shown on the left, or the device 101 may simply sit on a desktop, as shown on the right.

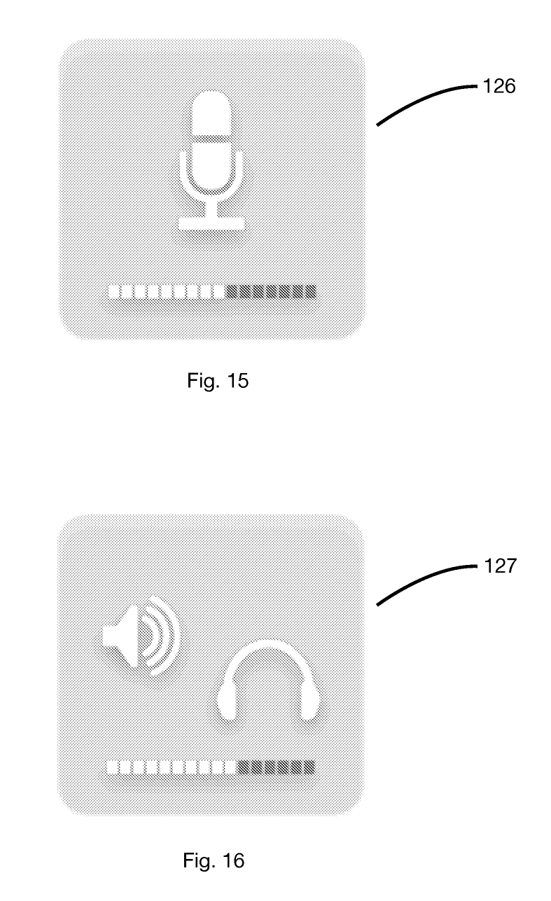

FIG. 14 depicts embodiments of icons 104, 105, 107 and 108 that may appear on an embodiment of the portable audio device or on the host computer or both, to provide visual feedback to the user.

FIG. 15 depicts an embodiment of an icon presented by the host computer or other device as a heads-up display-input indicator 126. FIG. 16 depicts an embodiment of an icon presented by the host computer or other device as a heads-up display-output indicator 127.

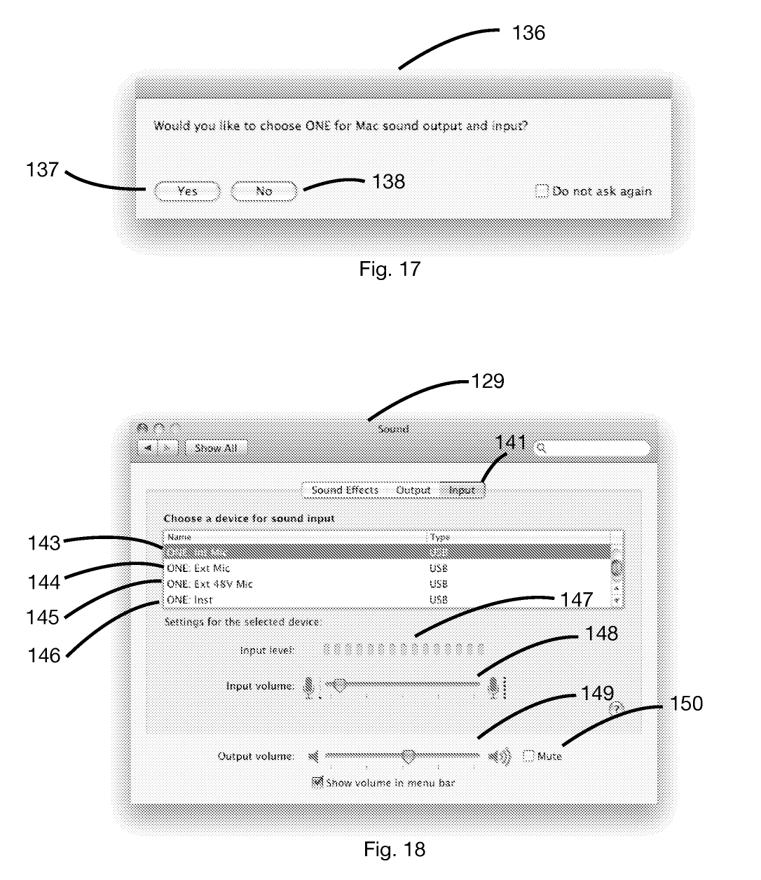

FIG. 17 depicts an embodiment of a host computer or other device communicating with an embodiment to allow for audio input and output from the embodiment via the host computer or other device. A dialog box or other sound in/out chooser window 136 may include buttons for “Yes” 137 or “No” 138.

FIG. 18 depicts an embodiment of a host computer or other device communicating with an embodiment to allow for remote switching of the input mode, input volume and output volume of an embodiment, as well as audio input level and muting function. A sound control panel window 129 may have a sound-input-tab 141, which may be selected to present choices for a source-internal mic 143, a source-external microphone 144, a source-external 48-volt microphone 145, a source-instrument 146, an input level meter 147, an input volume slider 148, an output volume slider 149, and a mute volume checkbox 150.

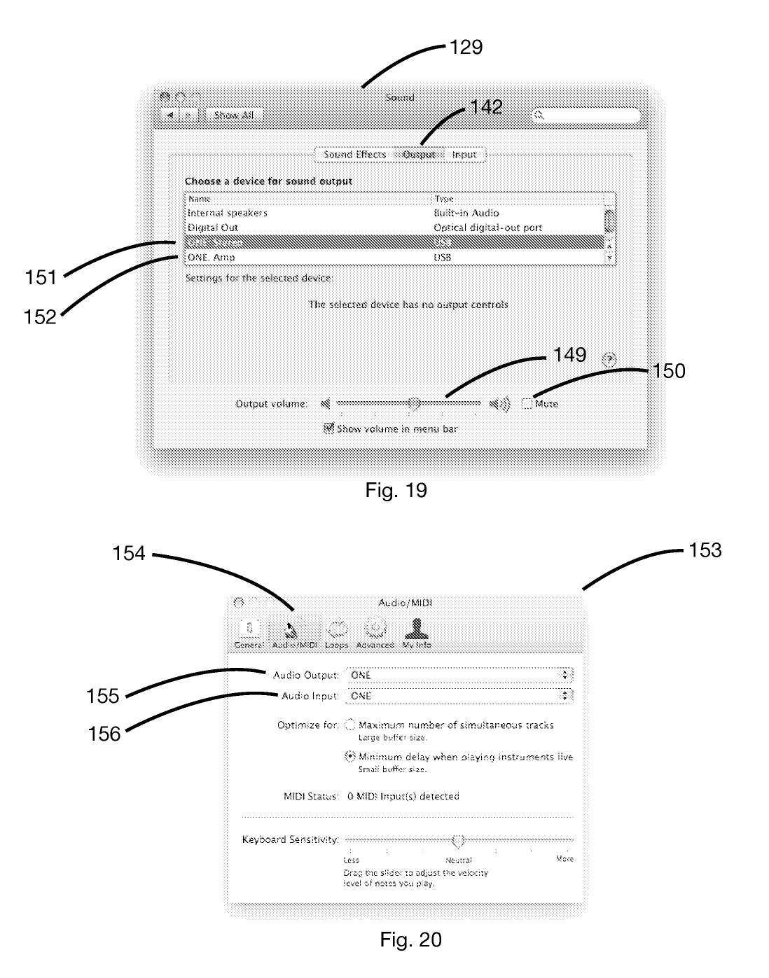

FIG. 19 depicts an embodiment of the sound control panel window 129 allowing for remote switching of the output mode and output volume of an embodiment, as well as muting function. A sound-output-tab 142 may present choices for output volume slider 149, mute volume checkbox 150, output stereo 151 and output amp 152.

FIG. 20 depicts a host computer or other device sound recording application allowing for an embodiment to directly access the application and stream audio to and from the host computer or other device via the sound recording application. Controls may include application-specific controls, for applications such as but limited to Garageband™, may include an application-audio/Midi window 153, an application-audio/Midi select tab 154, an application-audio/Midi audio input 155, and an application-audio/Midi audio output 156.

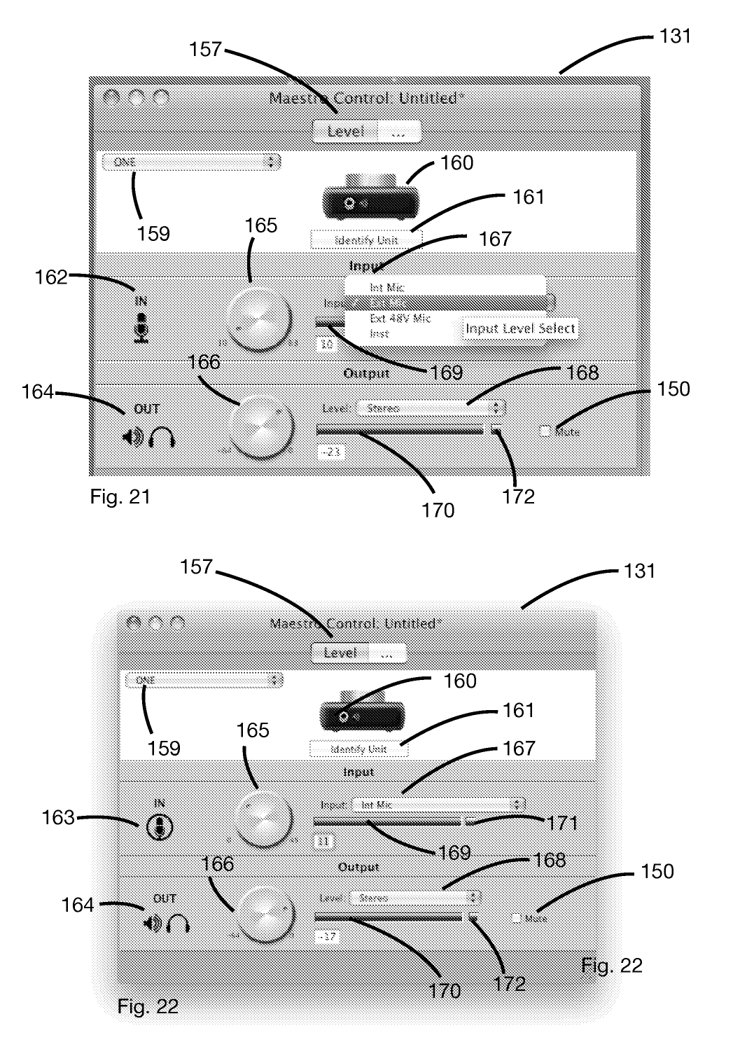

FIG. 21 depicts a stand-alone monitoring and controlling application, allowing for the remote control of all parameters of an embodiment, in particular the switching of the source input and allowing metering of the audio input and outputs of an embodiment. Controls for an application-specific screen, for applications such as but limited to Maestro™, may include an application level screen 157 may include a peripheral unit selector 159, a selected unit icon 160, an identify unit switch 161, and an external mic icon 162. Additional controls may include an headphones icon 164, an input level controller 165, an output level controller 166, an input source popup 167, an output mode popup 168, an input level meter 169, an output level meter 170, and an output level over indicator 172.

FIG. 22 depicts further options in the embodiment of FIG. 21. Controls for the selected unit level screen 157 may include an internal mic icon 163, and an input level over indicator 171.

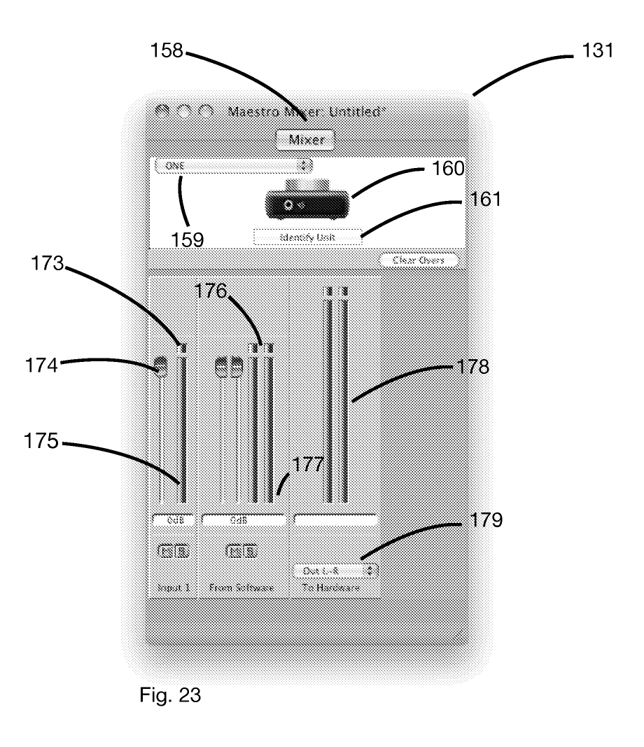

FIG. 23 depicts an application for audio mixing. Controls for a mixer screen 158, including but not limited to Maestro™, may include an input 1 slider 174, input 1 meter 175 and over-indicator 173, from-software application input meter 177 and over-indicator 176, and a to-hardware slider 178 and selector 179.

I claim:

1. A device comprising:
a portable housing having a wall;
an aperture in the wall;
a microphone inside the housing, in line with the aperture;
a controller that extends out of the wall; and
an audio output;
wherein the device receives sound through the aperture, provides an audio signal representing the sound through the audio output, and controls the strength of the audio signal with the controller.

2. The device of claim 1, wherein the aperture has sloped sides forming a large end and a small end, the large end opening out of the housing and the small end opening into the housing so that the sound enters the device and passes to the microphone.

3. The device of claim 2, wherein the sides of the aperture are sloped between 15 and 45 degrees relative to a central axis of the aperture.

4. The device of claim 1, further comprising:
an analog-to-digital converter that convert an analog audio signal, representing sound, to digital data; and
a digital-to-analog convert that converts the digital data into the audio signal provided through the audio output.

5. The device of claim 1, wherein the controller is rotated to control the strength of the audio signal.

6. The device of claim 1, wherein upon being operated by a user, the controller affects gain for the microphone, the controller affects amplification of the audio signal, and the controller changes input modes.

7. The device of claim 1, further comprising:
a second wall, generally perpendicular to the first wall; and
an interface for the audio output that extends through the second wall.

8. The device of claim 1, wherein the portable housing is small enough to be held and operated in a hand of a person.

9. The device of claim 1, wherein the portable housing has a length from 120 millimeters to 240 millimeters and a width from 56 millimeters to 120 millimeters.

10. The device of claim 1, further comprising:
an elastomer dampener for the microphone that resists transmission of vibrations from the housing to the microphone.

11. The device of claim 1, further comprising:
a plurality of audio inputs;
wherein the amplified audio signal represents a signal from one of the audio inputs that has been converted to digital data.

12. The device of claim 1, further comprising:
an external connection for a second input, which may include a microphone; and
a 48-volt power source for the second input.

13. The device of claim 1, further comprising:
a meter on the housing that displays an input level for the microphone and an output level for the audio output.

14. The device of claim 1, further comprising:
a serial communication interface to connect the device to a host;
wherein the device provides a first control input through the interface to the host, and the host provides a second control input through the interface to the device.

15. A device comprising:
a generally portable housing;
an aperture in the housing having sides sloped between 15 and 45 degrees relative to a central axis of the aperture with a large end that opens out of the housing and a small end that opens into the housing;
a microphone inside the housing, in line with the aperture, so that sound enters the device and passes to the microphone;
an audio output that provides an audio signal representing the sound;
a meter on the housing that displays an input level for the microphone and an output level for the audio output; and
a controller that controls the input level and the output level.

16. The device of claim 15, further comprising:
an external instrument input;
an analog-to-digital converter for the microphone and the external instrument input; and
a digital-to-analog converter for the audio output.

17. The device of claim 15, further comprising:
an elastomer dampener for the microphone that resists vibrations.

18. The device of claim 15, further comprising:
a plurality of audio inputs including an input for an external microphone; and
a 48-volt power source for the external microphone;
wherein the amplified audio signal represents a signal from one of the audio inputs.

19. A method of providing an audio signal, comprising:
passing sound through an aperture in the wall of a portable housing;
receiving the sound into a built-in microphone inside the housing, located at an end of the aperture;
amplifying an audio signal from the microphone;
utilizing a controller that extends out of the housing to control the amplification of the audio signal; and
providing the amplified signal to an audio output.

20. The method of claim 19, further comprising:
dampening the microphone relative to the housing so as to resist transmission of vibrations.
